(19) United States
(12) Patent Application Publication
(10) Pub. No.: US 2023/0156469 A1
(43) Pub. Date: May 18, 2023

(54) WIRELESS COMMUNICATION APPARATUS AND SERVER APPARATUS

(71) Applicant: KYOCERA Corporation, Kyoto (JP)

(72) Inventor: Keiji MURAKAMI, Kawasaki-shi (JP)

(73) Assignee: KYOCERA Corporation, Kyoto (JP)

(21) Appl. No.: 18/157,514

(22) Filed: Jan. 20, 2023

Related U.S. Application Data
(63) Continuation of application No. PCT/JP21/27420, filed on Jul. 21, 2021.

(30) Foreign Application Priority Data
Jul. 28, 2020 (JP) 2020/127747

(51) Int. Cl. H04W 12/069; H04W 76/15; H04W 12/72

(52) U.S. Cl. CPC H04W 12/069; H04W 12/72; H04W 76/15

(57) ABSTRACT

A wireless communication apparatus includes a storage, a communicator configured to perform wireless communication with a cellular network, and a controller configured to establish a first wireless connection with the cellular network when available Subscriber Identity Module (SIM) information is not stored in the storage, the first wireless connection being an unencrypted connection. The communicator is configured to transmit predetermined information to the cellular network through the first wireless connection, the predetermined information being used to establish a second wireless connection with the cellular network, and the second wireless connection being an encrypted connection. The controller is configured to, after the first wireless connection is released, establish the second wireless connection with the cellular network by using the predetermined information. The communicator is configured to receive the available SIM information through the second wireless connection.

### RELATED APPLICATIONS

The present application is a continuation based on PCT Application No. PCT/JP2021/027420, filed on Jul. 21, 2021, which claims the benefit of Japanese Patent Application No. 2020-127747 filed on Jul. 28, 2020. The content of which is incorporated by reference herein in their entirety.

### TECHNICAL FIELD

The present invention relates to a wireless communication apparatus and a server apparatus.

### BACKGROUND OF INVENTION

In order for a wireless communication apparatus to receive a cellular communication service from a communication operator, Subscriber Identity Module (SIM) information (e.g., an International Mobile Subscriber Identity (IMSI)) corresponding to the communication operator is required.

In recent years, a SIM management apparatus is widely used that manages a plurality of pieces of SIM information, each of which corresponds to a respective one of a plurality of communication operators.

The wireless communication apparatus acquires, from the SIM management apparatus, the SIM information appropriate for the wireless communication apparatus itself (e.g., SIM information corresponding to a communication operator at a location of the wireless communication apparatus) and stores the SIM information in a storage. The wireless communication apparatus uses the stored SIM information to receive a cellular communication service from a communication operator corresponding to the SIM information (e.g., see Patent Literature 1).

### Citation List

### Patent Literature

Patent Literature 1: JP 2013-505658 T

### SUMMARY

In a first aspect, a wireless communication apparatus includes a storage, a communicator configured to perform wireless communication with a cellular network, and a controller configured to establish a first wireless connection with the cellular network when available Subscriber Identity Module (SIM) information is not stored in the storage, the first wireless connection being an unencrypted connection. The communicator is configured to transmit predetermined information to the cellular network through the first wireless connection, the predetermined information being used to establish a second wireless connection with the cellular network, and the second wireless connection being an encrypted connection. The controller is configured to, after the first wireless connection is released, establish the second wireless connection with the cellular network by using the predetermined information. The communicator is configured to receive the available SIM information through the second wireless connection.

In a second aspect, a server apparatus includes a communicator configured to receive, from a wireless communication apparatus, predetermined information used to establish an encrypted wireless connection between the wireless communication apparatus and a cellular network, through an unencrypted wireless connection between the wireless communication apparatus and the cellular network.

### BRIEF DESCRIPTION OF THE DRAWINGS

FIG. 1 is a diagram illustrating a configuration of a mobile communication system according to an embodiment.

FIG. 2 is a diagram illustrating a configuration of a wireless communication apparatus 100 according to an embodiment.

FIG. 3 is a diagram illustrating a configuration of a base station 200 according to an embodiment.

FIG. 4 is a diagram illustrating a configuration of a core network apparatus 400 according to an embodiment.

FIG. 5 is a diagram illustrating a configuration of a server apparatus 300 according to an embodiment.

FIG. 6 is a diagram illustrating an operation example of a mobile communication system according to an embodiment.

### DESCRIPTION OF EMBODIMENTS

When a wireless communication apparatus acquires SIM information from a SIM management apparatus, a wireless communication means for accessing the SIM management apparatus is required. In particular, when a storage of the wireless communication apparatus includes no SIM information, such a wireless communication means needs to be provided separately, which problematically leads to inefficiency.

In view of this, the object of the present disclosure is to efficiently acquire the SIM information from the SIM management apparatus.

A cellular communication system according to an embodiment will be described with reference to the drawings. In the description of the drawings, the same or similar parts are denoted by the same or similar reference signs.

### Configuration of Mobile Communication System

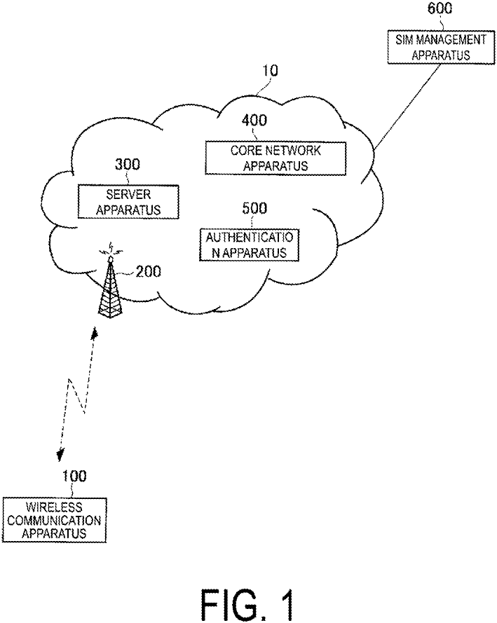

FIG. 1 is a diagram illustrating a configuration of a mobile communication system 1 according to an embodiment.

As illustrated in FIG. 1, the mobile communication system 1 includes a wireless communication apparatus 100, a SIM management apparatus 600, and a cellular network 10.

The wireless communication apparatus 100 may be any wireless communication apparatus, such as a communication module, an IoT apparatus, a mobile phone, a smartphone, and a personal computer.

The SIM management apparatus 600 manages a plurality of pieces of SIM information, each of which corresponds to a respective one of a plurality of different communication operators. The SIM information is information stored in a SIM card issued by the communication operator. The SIM information includes subscriber identification information for identifying a subscriber, operator identification information for identifying a communication operator, and contract information related to available services to which a subscriber has subscribed. The subscriber identification information is, for example, an International Mobile Subscriber Identity (IMSI).

The SIM management apparatus 600 transmits, to the wireless communication apparatus 100, the SIM information appropriate for the wireless communication apparatus 100 in response to a request from the wireless communication apparatus 100.

For example, the SIM management apparatus 600 manages X SIM cards corresponding to a communication operator A of a country A, Y SIM cards corresponding to a communication operator B of a country B, and Z SIM cards corresponding to a communication operator C of a country C. The SIM management apparatus 600 stores pieces of SIM information, each of which corresponds to a respective one of these SIM cards. The SIM management apparatus 600 transmits, to the wireless communication apparatus 100, the SIM information corresponding to one SIM card of X SIM cards corresponding to the communication operator A, in response to receiving a request message including information indicating that the wireless communication apparatus 100 is in the country A.

The SIM management apparatus 600 communicates with the cellular network 10 via another network (e.g., the Internet).

The cellular network 10 may support any mobile communication scheme including the second generation mobile communication scheme such as Global System for Mobile communications (GSM) (trade name), the third generation mobile communication scheme such as Code Division Multiple Access (CDMA), the fourth generation mobile communication scheme such as Long Term Evolution (LTE), and further the fifth generation mobile communication scheme. Such a mobile communication scheme may be referred to as Radio Access Technology (RAT). The fifth generation mobile communication scheme may be referred to as New RAT (NR). Such a mobile communication scheme may be a mobile communication scheme defined by a standardization entity. The standardization entity may be the 3rd Generation Partnership Project (3GPP), the Institute of Electrical and Electronics Engineers (IEEE), or the like.

The cellular network 10 includes a base station 200, a server apparatus 300, a core network apparatus 400, and an authentication apparatus 500.

The base station 200 provides a mobile communication service in a coverage area of the base station 200 by using at least one of the above-described mobile communication schemes. Such a coverage area may be referred to as a “cell”. The base station 200 manages one or more cells.

The core network apparatus 400 performs location management of the wireless communication apparatus 100, subscriber authentication, security, and the like. An example of the core network apparatus is a Mobility Management Entity (MME) or an Access and Mobility Management Function (AMF).

The authentication apparatus 500 includes a subscriber database in which the subscriber identification information of the subscriber and a shared key corresponding to the subscriber are associated with each other, and stored, the subscriber having a contract with the communication operator managing the cellular network 10. The SIM information held by the wireless communication apparatus 100 includes the subscriber identification information and the shared key. The shared key may be referred to as a K value.

The authentication apparatus 500 performs a shared key based authentication procedure on the wireless communication apparatus 100 accessing the cellular network 10. This encrypts a wireless connection between the wireless communication apparatus 100 and the cellular network 10.

The authentication procedure is a procedure for verifying the consistency between the shared key on the wireless communication apparatus 100 side and the shared key on the authentication apparatus 500 side. An example of such an authentication procedure is an Authentication and Key Agreement (AKA) procedure defined in the 3GPP. The AKA procedure is as follows.

Firstly, the core network apparatus 400 in the cellular network 10 acquires the subscriber identification information from the wireless communication apparatus 100, and transmits an authentication data request message including the subscriber identification information to the authentication apparatus 500.

Secondly, the authentication apparatus 500 refers to the subscriber database to identify the shared key to be associated with the received subscriber identification information, and calculates an expected response value by applying an algorithm to the shared key. The authentication apparatus 500 transmits, to the core network apparatus 400, an authentication data response message including the expected response value and algorithm information indicating the algorithm.

Thirdly, the core network apparatus 400 transmits a user authentication request message including the algorithm information to the wireless communication apparatus 100.

Fourthly, the wireless communication apparatus 100 calculates a response value by applying, to the shared key, an algorithm same as, and/or similar to, the algorithm applied by the authentication apparatus 500 regarding the algorithm, and transmits a user authentication response message including the response value to base station 200.

Fifthly, the core network apparatus 400 compares the expected response value with the response value and determines that the authentication procedure is successful if the expected value is the same as, and/or similar to the response value.

In response to the success of the authentication procedure, a wireless communication between the wireless communication apparatus 100 and the cellular network 10 is encrypted. This allows the wireless communication apparatus 100 to receive cellular communication services from the cellular network 10.

The server apparatus 300 performs each process related to the shared key described below.

### Configuration of Wireless Communication Apparatus

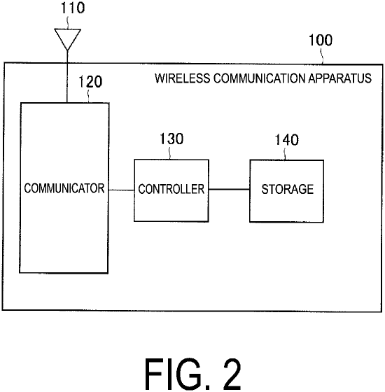

FIG. 2 is a diagram illustrating a configuration of the wireless communication apparatus 100 according to an embodiment.

As illustrated in FIG. 2, the wireless communication apparatus 100 includes an antenna 110, a communicator 120, a controller 130, and a storage 140.

The antenna 110 transmits and receives radio signals to and from the base station 200. The communicator 120 performs wireless communication with the base station 200 via the antenna 110.

The communicator 120 supports at least one of the above-described mobile communication schemes. The communicator 120 receives the SIM information from the SIM management apparatus 600 through the wireless communication.

The controller 130 performs various types of processing and control in the wireless communication apparatus 100. The controller 130 includes at least one processor. The processor may include a baseband processor and a Central Processing Unit (CPU). The baseband processor performs modulation and demodulation, coding and decoding, and the like of a baseband signal. The CPU performs various types of processing by executing programs stored in the storage 140. The controller 130 stores the SIM information received by the communicator 120 in the storage 140.

The storage 140 stores the programs to be executed by the controller 130, and information and data to be used for the processing by the controller 130. The storage 140 includes a volatile memory and a non-volatile memory.

The storage 140 includes a SIM information region provided to store the SIM information received by the communicator 120. The non-volatile memory includes the SIM information region.

The controller 130 receives the cellular communication service from the communication operator corresponding to the SIM information by using the SIM information stored in the SIM information region.

When the SIM information is not stored in the SIM information region, the controller 130 is basically incapable of receiving the cellular communication service, but is capable of receiving some restricted cellular communication services. For example, when the SIM information is not stored in the SIM information region, the wireless communication apparatus 100 can establish an unencrypted wireless connection with the cellular network 10 as described below.

### Base Station

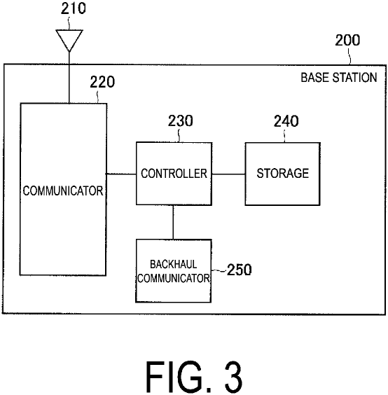

FIG. 3 is a diagram illustrating a configuration of the base station 200 according to an embodiment.

As illustrated in FIG. 3, the base station 200 includes an antenna 210, a communicator 220, a controller 230, a storage 240, and a backhaul communicator 250.

The antenna 210 transmits and receives radio signals to and from the wireless communication apparatus 100. The communicator 220 performs wireless communication of the wireless communication apparatus 100 via the antenna 210.

The communicator 220 supports at least one of the above-described mobile communication schemes.

The controller 230 performs various types of processing and control in the base station 200. The controller 230 includes at least one processor. The processor may include a baseband processor and a CPU. The baseband processor performs modulation and demodulation, coding and decoding, and the like of a baseband signal. The CPU performs various types of processing by executing programs stored in the storage 240.

The storage 240 stores the programs to be executed by the controller 230, and information and data to be used for the processing by the controller 230.

The backhaul communicator 250 is connected to the core network apparatus 400 via an interface between the base station and the core network. The backhaul communicator 250 is connected to a neighboring base station via an inter-base station interface.

### Core Network Apparatus

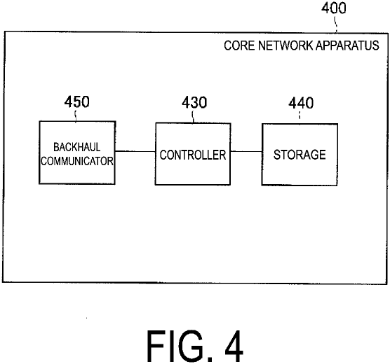

The core network apparatus 400 according to an embodiment will be described. FIG. 4 is a diagram illustrating a configuration of the core network apparatus 400 according to an embodiment.

As illustrated in FIG. 4, the core network apparatus 400 includes a controller 430, a storage 440, and a backhaul communicator 450.

The controller 430 performs various types of processing and control in the core network apparatus 400. The controller 430 includes at least one processor.

The storage 440 stores the programs to be executed by the controller 430, and information and data to be used for the processing by the controller 430.

The backhaul communicator 450 is connected to the base station 200 via the interface between the base station and the core network.

### Server Apparatus

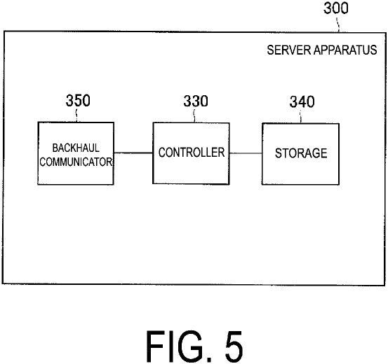

The server apparatus 300 according to an embodiment will be described. FIG. 5 is a diagram illustrating a configuration of the server apparatus 300 according to an embodiment.

As illustrated in FIG. 5, the server apparatus 300 includes a controller 330, a storage 340, and a backhaul communicator 350.

The controller 330 performs various types of processing and control in the server apparatus 300. The controller 330 includes at least one processor. The processor executes the programs stored in the storage 340 to perform various types of processing.

The storage 340 stores the programs to be executed by the controller 330, and information and data to be used for the processing by the controller 330.

The backhaul communicator 350 is connected to each of the base station 200, the core network apparatus 400, and the authentication apparatus 500 via predetermined interfaces.

The wireless communication apparatus 100 configured as described above needs to access the SIM management apparatus 600 to acquire the available SIM information when the SIM information is not stored in the storage 140, or when the SIM information stored in the storage 140 is not available. Here, “the SIM information is not available” means that the communication operator corresponding to the SIM information is not a communication operator in a region (country) where the wireless communication apparatus 100 is located, that the subscriber corresponding to SIM information has canceled the contract, and the like.

The wireless communication apparatus 100 needs to perform the authentication procedure with the cellular network 10 (authentication apparatus 500) to establish an encrypted wireless connection with the cellular network 10 in order to access the SIM management apparatus 600.

However, since the wireless communication apparatus 100 does not hold the available SIM information (or the available SIM information is not stored in the storage 140), the wireless communication apparatus 100 does not have the shared key necessary to perform the authentication procedure, and cannot perform the authentication procedure.

The embodiment is an embodiment for solving such a problem.

In an embodiment, the wireless communication apparatus 100 transmits predetermined information for calculating the shared key to the server apparatus 300 in the cellular network 10 through a first wireless connection, which is unencrypted, with the cellular network 10. The wireless communication apparatus 100 calculates the shared key based on the predetermined information.

The server apparatus 300 receives the predetermined information through the first wireless connection, and calculates the shared key based on the received predetermined information. The server apparatus 300 transmits the calculated shared key to the authentication apparatus 500. The authentication apparatus 500 stores the shared key.

This allows the shared key to be shared between the wireless communication apparatus 100 and the authentication apparatus 500.

The wireless communication apparatus 100 establishes a second wireless connection, which is encrypted, with the cellular network 10 by performing the shared key based authentication procedure with the authentication apparatus 500.

The wireless communication apparatus 100 accesses the SIM management apparatus 600 through the second wireless connection and receives available SIM information from the SIM management apparatus 600.

This allows the wireless communication apparatus 100, which holds no available SIM information, to acquire available SIM information from the SIM management apparatus 600.

The predetermined information is transmitted through the first wireless connection unencrypted, and may be intercepted by another wireless communication apparatus 100 (a wireless communication apparatus 100 which is not transmitting the predetermined information). Once having intercepted the predetermined information, another wireless communication apparatuses 100 can perform the shared key based authentication procedure, which negatively affects security of the cellular network 10.

The server apparatus 300 sets a validity period for the shared key, and when the validity period expires, the server apparatus 300 transmits a request to delete the shared key to the authentication apparatus 500. Thus, while the predetermined information is intercepted by another wireless communication apparatus 100, the security of the cellular network 10 is not negatively affected after the validity period expires.

### Operation Example

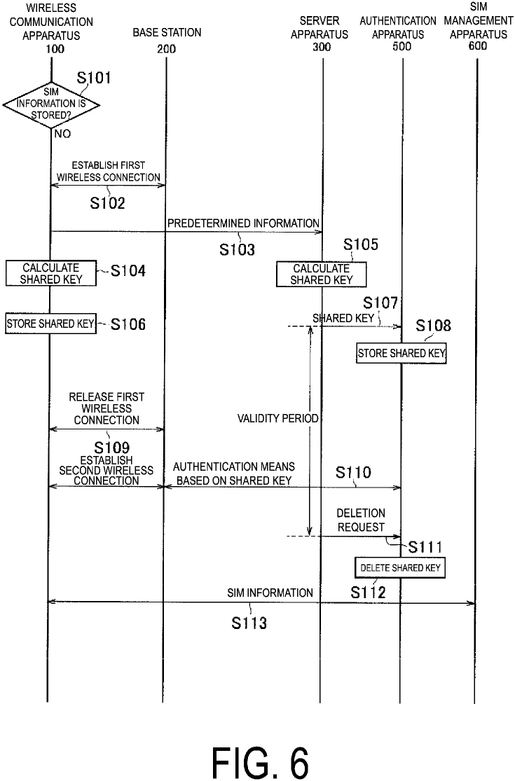

FIG. 6 is a diagram illustrating an operation example of a mobile communication system according to an embodiment.

In step S101, the wireless communication apparatus 100 (controller 130) determines whether the available SIM information is stored in the storage 140. Here, when the SIM information is not stored in the storage 140 or the SIM information stored in the storage 140 is not available, the wireless communication apparatus 100 determines that the available SIM information is not stored in the storage 140, and proceeds to the processing of step S102.

In step S102, the wireless communication apparatus 100 (controller 130) performs a connection procedure with the base station 200, and establishes the first wireless connection. The first wireless connection is an unencrypted connection. For example, in the connection procedure, the wireless communication apparatus 100 notifies the base station 200 that the wireless communication apparatus 100 wants to establish a wireless connection for transmitting the predetermined information for generating the shared key. The base station 200 (core network apparatus 400) completes the connection procedure without performing the authentication procedure and establishes an unencrypted first wireless connection.

In step S103, the wireless communication apparatus 100 (communicator 120) transmits the predetermined information to the server apparatus 300.

The predetermined information includes at least random number information indicating a random number calculated in the wireless communication apparatus 100. The predetermined information may further include information indicating a time (current time) when the predetermined information is transmitted. The random number may have a format of IMSI. The random number having the format of IMSI may be used in the authentication procedure (the AKA procedure described above) as the temporary subscriber identification information of the wireless communication apparatus 100.

In step S104, the wireless communication apparatus 100 (controller 130) calculates the shared key based on the predetermined information.

In step S105, the server apparatus 300 (controller 430) calculates the shared key based on the predetermined information.

Here, the wireless communication apparatus 100 and the server apparatus 300 calculate the shared key by applying the same algorithm to the predetermined information. Such an algorithm may be shared in advance between the wireless communication apparatus 100 and the server apparatus 300. The server apparatus 300, in response to receiving the predetermined information, may notify the wireless communication apparatus 100 of the algorithm.

In step S106, the wireless communication apparatus 100 (controller 130) stores the calculated shared key in the storage 140. When the random number based on when the shared key is calculated has the format of IMSI, the wireless communication apparatus 100 stores the random number, as the subscriber identification information of the wireless communication apparatus 100, in association with the shared key.

In step S107, the server apparatus 300 transmits the calculated shared key to the authentication apparatus 500. When the random number based on when the shared key is calculated has the format of IMSI, the server apparatus 300 transmits the random number as the subscriber identification information of the wireless communication apparatus 100 together with the shared key. The server apparatus 300, in response to transmitting the shared key, sets the validity period for the shared key, and starts a first timer having a first timer value equal to a length of the validity period.

In step S108, the authentication apparatus 500 stores the shared key. When the random number (subscriber identification information) is transmitted together with the shared key in step S107, the authentication apparatus 500 stores the shared key in association with the random number.

In accordance with the processing of steps S102 to S108, the shared key is shared between the wireless communication apparatus 100 and the authentication apparatus 500.

In step S109, the wireless communication apparatus 100 releases the first wireless connection.

In step S110, the wireless communication apparatus 100 establishes the second wireless connection (encrypted wireless connection) with the base station 200.

Specifically, the wireless communication apparatus 100 performs the shared key based authentication procedure with the authentication apparatus 500 during the connection procedure with the base station 200. This allows the second wireless connection encrypted to be established between the wireless communication apparatus 100 and the base station 200.

Here, when the wireless communication apparatus 100 stores the subscriber identification information in step S106, the wireless communication apparatus 100 may perform the AKA procedure described above as the authentication procedure.

In step S111, the server apparatus 300 transmits a request to delete the shared key to the authentication apparatus 500, in response to expiration of the first timer started in step S107.

In step S112, the authentication apparatus 500 deletes the shared key stored in step S108.

In step S113, the wireless communication apparatus 100 accesses the SIM management apparatus 600 through the second wireless connection to acquire the available SIM information from the SIM management apparatus 600. The wireless communication apparatus 100 uses the acquired SIM information to receive the cellular communication service from the communication operator corresponding to the SIM information.

In the operation example described above, after the server apparatus 300 performs the processing in step S107, the server apparatus 300 may transmit information indicating a second timer value smaller than the first timer value to the wireless communication apparatus 100 through the first wireless connection. The wireless communication apparatus 100 starts the second timer having the second timer value in response to receiving the information, and performs the processing of step S110 to step S111 before the second timer expires. Accordingly, the wireless communication apparatus 100 can establish the second wireless connection before the shared key is deleted in the authentication apparatus 500.

### Other Embodiments

In the embodiment described above, the server apparatus 300 is separate from the base station 200, but the server apparatus 300 and the base station 200 may constitute a single network apparatus. In this case, the processing performed by the server apparatus 300 in the above-described embodiment may be performed by the base station 200.

In the embodiment described above, the server apparatus 300 is separate from the core network apparatus 400, but the server apparatus 300 and the core network apparatus 400 may constitute a single network apparatus. In this case, the processing performed by the server apparatus 300 in the above-described embodiment may be performed by the core network apparatus 400.

A program that causes a computer to execute each of the processing operations according to the embodiments described above may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM.

Embodiments have been described above in detail with reference to the drawings, but specific configurations are not limited to those described above, and various design variation can be made without departing from the gist of the present disclosure.

### Reference Signs

1: Mobile communication system
10: Cellular network
100: Wireless communication apparatus
110: Antenna
120: Communicator
130: Controller
140: Storage
200: Base station
210: Antenna
220: Communicator
230: Controller
240: Storage
250: Backhaul communicator
300: Server apparatus
330: Controller
340: Storage
350: Backhaul communicator
400: Core network apparatus
430: Controller
440: Storage
450: Backhaul communicator
450: Backhaul communicator
600: SIM management apparatus

1. A wireless communication apparatus comprising:
a storage;
a communicator configured to perform wireless communication with a cellular network; and
a controller configured to establish a first wireless connection with the cellular network when available Subscriber Identity Module (SIM) information is not stored in the storage, the first wireless connection being an unencrypted connection, wherein
the communicator is configured to transmit predetermined information to the cellular network through the first wireless connection, the predetermined information being used to establish a second wireless connection with the cellular network, and the second wireless connection being an encrypted connection,
the controller is configured to, after the first wireless connection is released, establish the second wireless connection with the cellular network by using the predetermined information, and
the communicator is configured to receive the available SIM information through the second wireless connection.

2. The wireless communication apparatus according to claim 1, wherein
the controller is configured to calculate a shared key based on the predetermined information,
the shared key is shared between the wireless communication apparatus and the cellular network, and
the controller is configured to perform a shared key based authentication procedure with the cellular network to establish the second wireless connection.

3. The wireless communication apparatus according to claim 2, wherein
the communicator is configured to transmit the predetermined information to a server apparatus in the cellular network through the first wireless connection,
the predetermined information includes random number information indicating a random number,
the communicator is configured to receive information indicating an algorithm from the server apparatus, and
the controller is configured to calculate the shared key by applying the algorithm to the random number.

4. The wireless communication apparatus according to claim 3, wherein the random number is used as subscriber identification information of the wireless communication apparatus in the authentication procedure.

5. The wireless communication apparatus according to claim 2, wherein
the communicator is configured to, after transmitting the predetermined information, receive information indicating a timer value based on validity period for the shared key from the cellular network, and
the controller is configured to start a timer having the timer value and establish the second wireless connection before the timer expires.

6. A server apparatus comprising:
a communicator configured to receive, from a wireless communication apparatus, predetermined information used to establish an encrypted wireless connection between the wireless communication apparatus and a cellular network, through an unencrypted wireless connection between the wireless communication apparatus and the cellular network.

7. The server apparatus according to claim 6, further comprising:
a controller configured to calculate a shared key based on the predetermined information, wherein
the communicator is configured to transmit the shared key to an authentication apparatus, and
the communicator is configured to transmit a request to delete the shared key to the authentication apparatus in response to elapse of a predetermined period after transmission of the shared key.
